(19) United States
(12) Patent Application Publication
(10) Pub. No.: US 2008/0205648 A1
(43) Pub. Date: Aug. 28, 2008

(54) APPARATUS, AND ASSOCIATED METHOD FOR LENGTHENING DATA COMMUNICATED IN A RADIO COMMUNICATION SYSTEM WITH PADDING BYTES

(75) Inventors: STEVE MICHAEL HANOV, WATERLOO (CA); MARIANA LYU, PLANO, TX (US)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(73) Assignee: RESEARCH IN MOTION LIMITED, WATERLOO (CA)

(21) Appl. No.: 11/679,661

(22) Filed: Feb. 27, 2007

(51) Int. Cl. H04K 1/00

(52) U.S. Cl. 380/270

(57) ABSTRACT

Apparatus, and an associated method, for facilitating transmission of block-formatted data by an EDGE-capable mobile station. When the mobile station is instructed to use an MCS-8 modulation coding scheme, in initial transmission of the data, the mobile station determines the amount of data that is to be transmitted. If only a single RLC block is to be transmitted at MCS-8, MCS-6 is instead utilized. And, padding bytes are added to the MCS-6 data blocks.

The present invention relates generally to a manner by which to communicate coded data in data radio, or other, communication system. More particularly, the present invention relates to apparatus, and an associated method, by which to alter the length of a coded data block to facilitate communication of data of which the data block forms a portion and to facilitate subsequent operations upon the data block.

Padding bytes are permitted, e.g., in data communicated by an EDGE (Enhanced Data for GSM Evolution)-capable mobile station. When an initial transmission data is to be communicated pursuant to an MCS-8 (Modulation Coding Scheme-8) coding scheme but only a single radio block is to be communicated, the data is instead communicated pursuant to an MCS-6 (Modulation Coding Scheme-6) in which padding bytes are added to the data blocks that together form the radio block. Six padding bytes are added to a 68-byte-length, MCS-6 coded data block to result in a data block of a 74-byte data block. The 74-byte length of the padded, data block corresponds with the 74-byte length of an MCS-8 coded data block.

### BACKGROUND OF THE INVENTION

The use of radio communication systems through which to communicate is pervasive in modern society. And, for many, ready access to a radio communication system is a practical necessity of every day life.

A cellular communication system is an exemplary type of radio communication system. The network infrastructures of cellular communication systems have been installed throughout significant portions of the populated areas of the world. Early-generation, cellular communication systems provided for voice communication services and limited data services. New-generation, cellular communication systems increasingly provide for high-speed data communication services as well as voice communication services. The different types of communication services are handled differently. For instance, due to the real-time nature of a voice communication service, any delay in communication adversely affects the quality of the communication service. That is to say, delay-free communication is of relatively greater significance than distortion-free communication. In contrast, real-time communication of data pursuant to a data communication service is generally of lesser importance than accuracy of the communicated data. That is to say, distortion-free communication is of relatively greater significance than delay-free communication pursuant to a data communication service.

A GSM/GPRS/EDGE (Global System for Mobile communications/General Packet Radio Service/Enhanced Data for GSM Evolution) communication system provides for voice and data communication services. The manner by which data is modulated and coded is selectable pursuant, e.g., an EDGE data service. The modulation and coding scheme is selectable, responsive to communication conditions. When communication conditions are poor, for instance, increased amounts of redundancy better facilitates communication of the informational content of the data. And, a reduced-complexity modulation scheme facilitates communication. Conversely, for instance, when communication conditions are good, amount of coding need not be as great while still permitting the informational content of the data to be recovered. And, a more complex modulation scheme is also able to be utilized. The reduced level of coding and increased-complexity modulation permits data to be communicated at a higher rate. By providing various modulation and coding schemes, the modulation and coding is selected to be of a level best to communicate the data. And, if communication conditions change, the modulation and coding scheme is reselectable, thereby to provide modulation and coding in a manner best to communicate the data in the changed communication conditions.

More specifically, in an EDGE-capable communication system, nine modulation and coding schemes, MCS-1 through MCS-9 are defined. Each MCS (Modulation Coding Scheme) defines a modulation-type and level of coding by which data that is to be communicated is modulated and coded. Additional parameters are defined by the MCS levels. For instance, data blocks, of which RLC (Radio Link Control)-layer blocks are formed are of designated byte lengths. For instance, an MCS-9 radio block contains two 74-byte RLC data blocks. An MCS-6 radio block is of a 74-byte length. Two MCS-6 sized RLC blocks are able to be transmitted in one MCS-9 radio block. And, for instance, an MCS-8 radio block contains two 68-byte RLC data blocks.

Additional protocols and procedures related to transmission, or retransmission, of a radio block are set forth in appropriate promulgations of standardized protocols and procedures. Additional communication proposals are also under consideration. For instance, one protocol proposal includes a procedure related to communication of MCS-8 data. If MCS-8 data is to be transmitted by a mobile station but there only is a single RLC block to be transmitted, the mobile station transmits the RLC block as an MCS-6 radio block. However, as noted above, the byte-lengths of the data blocks forming the radio blocks of the different MCS levels differ. Without compensation made for the different byte-lengths of the data blocks, subsequent problems occur when the different-length data blocks are recombined subsequent to transmission, or otherwise operated upon. While an existing scheme provides for use of padding bytes during retransmission of data, there is presently no mechanism provided for an initial transmission of data.

A manner is thereby required by which to make compensation for, or otherwise correct for, the differing byte-length sizes of the data blocks during an initial transmission of the data but fewer than 68 bytes of data are to be sent.

It is in light of this background information related to the communication of data pursuant to a communication service that the significant improvements of the present invention have evolved.

### BRIEF DESCRIPTION OF THE DRAWINGS

FIG. 1 illustrates a functional block diagram of a communication system in which an embodiment of the present invention is operable.

FIG. 2 illustrates a process block diagram representative of the process of operation of an embodiment of the present invention.

FIG. 3 illustrates a method flow diagram representative of the method of operation of an embodiment of the present invention.

### DETAILED DESCRIPTION

The present invention, accordingly, advantageously provides apparatus, and an associated method, by which to communicate coded data in a data radio, or other communication system.

Through operation of an embodiment of the present invention, a manner is provided by which to alter the length of a coded data block to facilitate communication of data block forms a part and to facilitate subsequent operations upon the data block, once communicated.

In one aspect of the present invention, an EDGE-capable mobile station is provided. Pursuant to operation of the mobile station, data is communicated pursuant to effectuation of a data communication service. Data is coded and modulated pursuant to a modulation and coding scheme of which multiple level, MCS-1 through MCS-9 are currently defined. A radio block that is to be communicated pursuant to effectuation of a data communication service is formed of data blocks, each of defined byte-lengths. Pursuant to conventional protocols, if MCS-8 modulation and coding is to be utilized in the communication of the data, but only a single RLC (radio) block remains to be transmitted, the radio block is, instead, MCS-6 modulated and coded, then sent.

In another aspect of the present invention, padding bytes are added to the MCS-6 data blocks, formed rather than MCS-8 data blocks in the event that only a single radio block is to be transmitted. Such padding bytes are added during an initial transmission of the data. An MCS-6 data block is of a 68-byte length. Six padding bytes are caused to be concatenated to, or otherwise added to, the data block to form a data block of a 74-byte length.

In another aspect of the present invention, a determination is made of the number of radio blocks that are to be transmitted. If the number of radio blocks that are to be transmitted at an MCS-8 level, is more than one, then operations continue in normal manner. That is to say, when there is a plurality of radio blocks to be transmitted in MCS-8, the data is modulated and coded in conformity with MCS-8 and transmitted as MCS-8 data blocks. If, however, only a single RLC block remains to be transmitted, or retransmitted in the event of data retransmission, a decision is made instead to utilize MCS-6 modulation and coding and to communicate the single RLC block as MCS-6 data blocks.

By permitting padding bytes to be added to the MCS-6 data blocks, each resultant data block of the RLC block is of a 74-byte length. If sixty-eight, or fewer, data bytes are to be transmitted in an initial transmission of such data at MCS-8, then, instead, the data is sent at MCS-6 with the use of the six padding bytes.

In another aspect of the present invention, the EDGE-capable mobile station is instructed in what manner to modulate and code data. Instructions are provided to the mobile station by the network infrastructure of the cellular communication system with which the mobile station is in communication connectivity. Determination is made at the network infrastructure as to the MCS level that the mobile station is to transmit data. That is to say, the network infrastructure requires the transmission to be of a selected MCS level. And, the network infrastructure instructs the mobile station to transmit data at the selected MCS level, such as by control commands broadcast by the network infrastructure to the mobile station. The mobile station operates in response to the instructions provided by the network infrastructure. If the MCS-8 level is the level that the network infrastructure instructs the mobile station to use for subsequent data transmission. If, however, only a single RLC block remains to be transmitted, an MCS-8 is the level that the network infrastructure instructs the mobile station to transmit the data for its initial transmission, the mobile station utilizes MCS-6 to communicate the data. Because MCS-6 blocks are of different byte-lengths than MCS-8 blocks, the MCS-6 blocks, once formed, are populated with additional padding bytes that, together with the MCS-6, coded data forms data blocks of 74-byte lengths.

Because the padding bytes are added to increase the length of each of the data blocks, the data blocks are more easily, subsequently operated upon, once delivered to a destination.

In these and other aspects, therefore, apparatus, and an associated method, is provided for transmitting data by a radio communication station. Selection is made to communicate a radio block formed of data blocks. The radio block is intended to be transmitted pursuant to a first coding scheme for its initial transmission. Selection to transmit the radio block is made to transmit the radio block pursuant to a second coding scheme. Padding is permitted to be added to the data block, coded pursuant to a second coding scheme. The data block, once padded, is of a data-block length corresponding to a data-block length of second-coding-scheme-defined length.

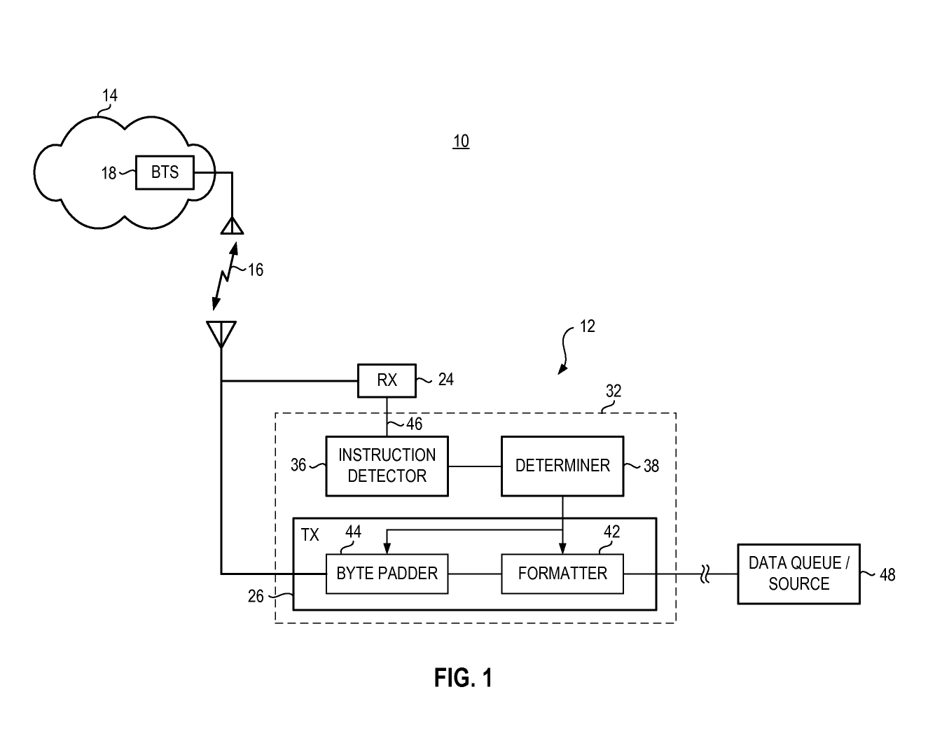

Referring first, therefore, to FIG. 1, an exemplary communication system, shown generally at 10, provides for radio communications with mobile stations, of which the mobile station 12 is representative. Data is communicated between the mobile station and the network part 14 by way of radio channels defined upon a radio air interface 16. The data is communicated between the mobile station and a base transceiver station (BTS) 18 of the network part in whose coverage area that the mobile station is positioned. In the exemplary implementation, the communication system forms a GSM/GPRS/EDGE (Global System for Mobile communications/General Packet Radio Service/Enhanced Data for GSM Evolution)-capable, cellular communication system. More generally, the communication system is representative of any of various radios, and other, communication systems in which block-formatted data is communicated. The following description shall describe operation with respect to the exemplary implementation in which EDGE-formatted data is communicated by the mobile station to the network part. In other implementations and embodiments, data is communicated in other directions and between other devices.

The mobile station 12 includes transceiver circuitry here represented by a receive part 24 and a transmit part 26. Data received at the mobile station is detected and operated upon by the receive part. And, data originated, or otherwise transmitted by, the mobile station is operated upon, and caused to be transmitted by, the transmit part. Pursuant to an EDGE-based communication service, EDGE-formatted data is communicated between the mobile station and the network part. The EDGE data is modulated and coded pursuant to a modulation and coding scheme, of which, presently, coding schemes MCS1 through MCS-9 are defined. Selection of the coding scheme that is to be utilized is made at the network part. Instructions are provided, such as by way of a control channel defined upon the radio air interface, by the network part to the mobile station to inform and instruct the mobile station of the modulation coding scheme that is to be utilized by the mobile station in the formation of EDGE-formatted blocks that are to be communicated upon a communication uplink in which the data is communicated by the mobile station to the network part.

As noted previously, protocols have been developed, and others proposed, that define data-block configuration pursuant to an EDGE-based format. In other communications, other protocols have analogously been set forth to provide for the communication of block-formatted data.

With respect to the communication of EDGE-formatted data pursuant to a selected modulation coding scheme, the modulation coding scheme that is used is determinative of the data-block characteristics. For instance, when the modulation coding scheme is an MCS-9 coding scheme, an MCS-9 radio block is defined that contains two 74-byte RLC data blocks. When, e.g., the modulation coding scheme is an MCS-8 scheme, an MCS-8 radio block contains two 68-byte RLC data blocks. And, when, e.g., the modulation scheme is an MCS-6 modulation coding scheme, an MCS-6 radio block is defined that is of a block-length of 74 bytes. Other modulation coding schemes define data blocks to be of other designated lengths. The data lengths and the amount of information contained in a data block is dependent upon the selected modulation coding scheme. The modulation coding scheme is selected, e.g., in a manner best to provide for communication of data between communication stations, i.e., the mobile station and a base transceiver station. As also noted previously, the modulation coding scheme is selected, in significant part, responsive to communication conditions on the radio air interface formed between the communication stations. As the communication conditions are generally time-varying, the selected modulation coding scheme that best facilitates communications might well also vary. Reselection of the modulation coding scheme that is utilized might, accordingly, need to be reselected. And, even without a reselection of the modulation coding scheme, the specifics of data to be communicated pursuant to a particular data communication service might well be more efficiently effectuated through use of a modulation coding scheme other that the modulation coding scheme that the network part selects to be utilized pursuant to the communication of the data.

The mobile station, accordingly, further includes apparatus, here designated at 32, of an embodiment of the present invention. The apparatus is formed of functional elements, implementable in any desired manner, including, for instance, by algorithms executable by processing circuitry. In the exemplary implementation, and as shown, various functions provided by the apparatus are performed at the transmit part 26 of the mobile station and the entities representative of such functions are shown in FIG. 1 to be embodied at, and form portions of, the transmit part 26.

The apparatus 32 is here shown to include an instruction detector 36, a determiner 38, a data block formatter 42, and a byte padder 44.

The instruction detector operates to detect reception at the receive part of instruction sent by the network part to the mobile station to instruct the mobile station of the modulation coding scheme to be used in the transmission of EDGE data by the mobile station. Indications of such reception are provided to the detector, here by way of the line 46. And, the determiner 38 operates responsive to a detected instruction to determine whether the detected instruction instructs the mobile station to utilize an MCS-8 coding scheme. As noted above, in a MCS-8 scheme, a radio block of data is formed of two 68-byte RLC data blocks. If so, further determination is made by the determiner as to whether the data instructed to be sent using MCS-8 should instead be sent as MCS-6 data. Such further determination is made by the determiner responsive to evaluation of the amount of data that is to be, or remains to be, communicated by the mobile station pursuant to the communication transmission. More particularly, the data, even when instructed to be communicated as MCS-8 data, is transmitted, or retransmitted, as MCS-6 data in the event that only one RLC block is to be transmitted. If, e.g., pursuant to an initial transmission of MCS-8 data sixty-eight or fewer bytes are to be sent, the data is sent as MCS-6 with padding bytes added.

Upon determination by the determiner that the data, instructed to be sent as MCS-8 data, is instead to be sent as MCS-6 data, the formatter 42 formats the data, here sourced at the data queue source 48, is formatted into an MCS-6 data block. And, the byte padder 44 pads the data blocks with padding bytes. Six padding bytes are added to a data block as an MCS-6 data block is of 74 bytes, while an MCS-8 block is of a 68-byte length. Once the padding bytes are added to the data of the data block, the data blocks are each of 74-byte lengths. Once the data block is formed and padded with padding bytes, the data blocks are provided to other transmit circuitry (not separately shown) of the transmit part and communicated by the mobile station to the network part.

The network part, upon reception of the communicated data performs operations thereon. In a scenario in which prior-communicated radio blocks are MCS-8 radio blocks, and the newly-transmitted data comprises an MCS-6 block, due to the use of padding bytes, the network part is able to combine the receive data into a single MCS-8 radio block.

Operation of the apparatus 32 of an embodiment of the present invention pertains, in part, to when a transmission of data, either an original transmission or a retransmission thereof, is required to be an MCS-8 but there is only one RLC block that is to be transmitted in the MCS-8. In such a scenario, the mobile station instead sends that block of data in MCS-6 in which padding is permitted.

In one example, the mobile station transmits data in an uplink TBF (Temporary Block Flow). The network instructs the data to be communicating using MCS-8. In this example, 170 bytes, including length indicators, remain to be transmitted. In MCS-8, data blocks are of 68-byte lengths. Therefore, 170/68=2.5 RLC data blocks in MCS-8. RLC filling octets, (different than the padding described above), rounds the number of blocks up to three. Further information related to RCC filling octets is set forth in 3GPP 44.060 Table 10.4.14a.1. As three RLC data blocks at MCS-8 would require the transmission of four data blocks. However, by using MCS-6 for the demodulation coding scheme of the third block, only the third block, in MCS-6, needs to be communicated.

In another example, a first radio block is transmitted using MCS-8 in which each of the two data blocks thereof are of 68-byte lengths. And, the second radio block utilizes MCS-6 with padding bytes. Thereafter, when the RLC data layer receives another LLC PDU from an upper logical layer of the communication device, that is of fewer than 68 bytes, a fourth RLC data block is communicated, again using MCS-6 together with padding bytes. That is to say, the third radio block is of MCS-6 with padding. Thereafter, in this example, the base transceiver station negatively acknowledges the second radio block communication, an MCS-6 of 68 bytes, and the third radio block, also of MCS-6 with padding, and the base station further instructs the mobile station to maintain the same MCS. As the RLC data blocks are transmitted with padding, such data blocks are combinable into a single MCS-8 radio block upon their retransmission.

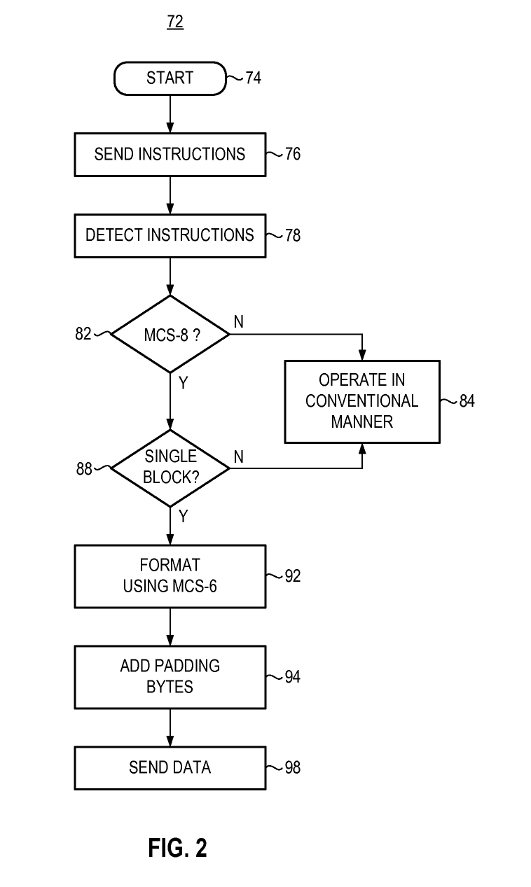

FIG. 2 illustrates a process diagram, shown generally at 72, representative of the process of operation of an embodiment of the present invention. After entry, indicated by the start block 74, instructions are sent indicated by the block 76 by the network to a mobile station to instruct the mobile station in what MCS to communicate data. The mobile station detects, indicated by the block 78, the instructions sent thereto. And, as indicated by the decision block 82, a determination is made as to whether the detected instructions instruct the mobile station to use MCS-8. If not, the no branch is taken and conventional operation, indicated by the block 84 continues. If, however, instructions are to utilize MCS-8, the yes branch is taken to the decision block 88. At the decision block 88, a determination is made as to whether one RLC block is to be transmitted at the MCS-8 level. If not, the no branch is taken to the block 84, and conventional operation commences. If, however, only a single RLC block is to be transmitted at MCS-8, the yes branch is taken to the block 92. At the block 92, the data is formatted using MCS-6 rather than MCS-8. And, as indicated by the block 94, padding bytes are concatenated, or otherwise added to, the MCS-6 data blocks. The data is then sent, indicated by the block 98.

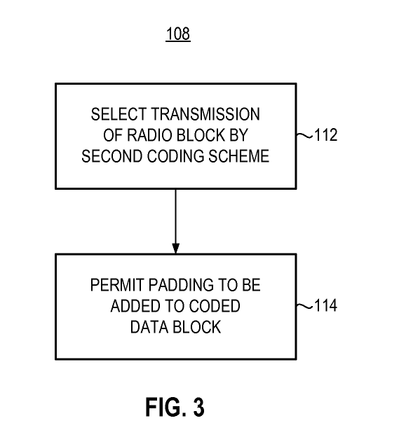

FIG. 3 illustrates a method flow diagram, shown generally at 108, representative of the method of operation of an embodiment of the present invention. The method facilitates transmission of data by a radio communication station.

First, and as indicated by the block 112, a radio block, formed of data blocks, that is intended to be transmitted in an initial transmission thereof pursuant to a first coding scheme is selected, instead, to be transmitted pursuant to a second coding scheme.

Then, and as indicated by the block 114, padding is permitted to be added to the data block, once coded pursuant to the second coding scheme. The padding is added such that the resultant data block is of a data-block length corresponding to a data-block length of a second-coding-scheme-defined length.

Improved communication efficiency is thereby provided as the MCS-6 level is used to reduce the data blocks that are required to be communicated pursuant to the communication service. If the data remaining to be transmitted is of a single MCS-8 RLC block, the data is sent as an MCS-6 block, obviating the need to send multiple MCS-8 blocks.

What is claimed is:

1. A method for transmitting data by a radio communication station, said method comprising the operation of:
selecting to transmit a radio block, formed of data blocks, intended to be transmitted in an initial transmission thereof pursuant to a first coding scheme, pursuant to a second coding scheme; and
permitting padding to be added to a data block, coded pursuant to the second coding scheme, of the radio block such that the data block, once padded, is of a data block length corresponding to a data-block length of a second-coding-scheme-defined length.

2. The method of claim 1 further comprising the operation of determining that the data to be transmitted comprises a single radio block intended to be transmitted pursuant to the first coding scheme, and wherein said operation of selecting is made responsive to determination made during said operation of determining.

3. The method of claim 1 wherein the radio communication relation comprises an EDGE, Enhanced Data for GSM Evolution, -capable mobile station, wherein the first coding scheme pursuant to which the radio block is intended to be transmitted, comprises an MCS-8, Modulation Coding Scheme-8, coding scheme, and wherein the second coding scheme pursuant to which the radio block is selected to be transmitted during said operation of selecting comprises an MCS-6, Modulation Coding Scheme6.

4. The method of claim 1 wherein said operation of permitting padding comprises padding the data block.

5. The method of claim 4 wherein said operation of padding the data block comprises padding the data block with six padding bytes.

6. The method of claim 1 wherein the data blocks of the radio block, when coded pursuant to the first coding scheme are each of 74-byte lengths.

7. The method of claim 6 wherein a radio block, when coded pursuant to the second coding scheme, comprises a pair of data blocks, each of 68-byte lengths.

8. The method of claim 7 wherein said operation of permitting padding comprises permitting padding of each data block of the pair of data blocks.

9. The method of claim 8 wherein said operation of permitting padding comprises permitting padding of 6 bytes to each of the data blocks of the pair of data blocks.

10. The method of claim 1 wherein said operation of permitting padding to be added to a data block comprises permitting padding to be added to each data block of a pair of data blocks.

11. A method of communicating a radio block by a mobile station, said method comprising the operations of:
requiring transmission of data at an MCS-8, Modulation Coding Scheme-8, coding scheme;
when the data, pursuant to initial transmission thereof, comprises a single RLC, Radio Link Control, block, forming the data into a pair of MCS-6, Modulated Coding Scheme-6, data blocks; and
padding the data blocks of the pair with padding bytes to increase byte lengths of the data bytes.

12. Apparatus for a radio communication station that transmits data, said apparatus comprising:
a selector configured to select to transmit a radio block formed of data blocks, intended to be transmitted, during initial transmission thereof, pursuant to a first coding scheme, pursuant to a second coding scheme;
a data block padding permitter adapted to receive indication of selection by said selector of selection to transmit the radio block pursuant to the second coding scheme, said data block padding permitter configured to permit padding to be added to a data block of the radio block, such that the data block, once padded, is of a data-block length corresponding to a data-block length of a second-coding-scheme-defined length.

13. The apparatus of claim 12 further comprising a determiner configured to determine that the data to be transmitted comprises a single radio block intended to be transmitted pursuant to the first coding scheme, and wherein selection made by said selector is made responsive to determination made by said determiner.

14. The apparatus of claim 12 wherein the radio communication station comprises an EDGE, Enhanced Data for GSM Evolution,-capable mobile station, wherein the first coding scheme pursuant to which the radio block is intended to be transmitted, comprises an MCS-8, Modulation Coding Scheme-8, coding scheme, and wherein the second coding scheme pursuant to which the radio block is selected to be transmitted by said selector comprises an MCS-6, Modulation Coding Scheme-6.

15. The apparatus of claim 12 wherein said data block padding permitter further comprises a data block padder.

16. The apparatus of claim 15 wherein said data block padder is further configured to pad the data block with six padding bytes.

17. The apparatus of claim 12 wherein the data blocks of the radio block, when coded pursuant to the first coding scheme are each of 74-byte lengths.

18. The apparatus of claim 17 wherein the radio block, when coded pursuant to the second coding scheme, comprises a pair of data blocks, each of 68-byte lengths.

19. The apparatus of claim 18 wherein said data block padder permitter is configured to permit padding of each data block of the pair of data blocks.

20. The apparatus of claim 19 wherein said data block padder is further configured to permit padding of 6 bytes to each of the data blocks of the data blocks.
